(19) United States
(12) Patent Application Publication
(10) Pub. No.: US 2016/0168414 A1
(43) Pub. Date: Jun. 16, 2016

(54) AQUEOUS COATING COMPOSITION WITH IMPROVED DURABILITY

(71) Applicants: DOW GLOBAL TECHNOLOGIES LLC, Midland, MI (US); ROHM AND HAAS COMPANY, Philadelphia, PA (US)

(72) Inventors: Juan LI, Shanghai (CN); Tao Wang, Shanghai (CN); Tao Wang, Highton (AU); Junyu Chen, Shanghai (CN); Longlan Cui, Shanghai (CN); Wei Cui, Shanghai (CN); David G. Speece, North Wales, PA (US)

(21) Appl. No.: 14/904,117

(22) PCT Filed: Jul. 31, 2013
(86) PCT No.: PCT/CN2013/080466

§ 371 Date: Jan. 11, 2016

(51) Int. Cl. C09D 133/12; C09D 125/14; C09D 133/08

(52) U.S. Cl. CPC C09D 133/12; C09D 133/08; C09D 125/14; C08K 3/22

(57) ABSTRACT

This invention relates to a coating composition and, especially, relates to an aqueous coating composition with improved durability.

### FIELD OF THE INVENTION

This invention relates to a coating composition and, especially, relates to an aqueous coating composition with improved durability.

### INTRODUCTION

Coating manufacturers use photocrosslinkers as a coating additive to achieve good dirt-pick-up-resistance properties (DPUR) in coating products. Widely used photocrosslinkers include benzophenone and its derivatives, phosphine oxide, and oxodiphenylmethane. Photocrosslinkers will initiate post crosslinking among polymers, increase the hardness of the coating films and, therefore, achieve good DPUR properties. Inorganic pigments, especially TiO₂, are another commonly used coating additive, usually used in large amounts. TiO₂, when exposed to sunlight, will release free radicals to degrade polymer backbones and even destroy the structure of polymers, adversely affecting coating durability. Coating durability could be detected by color retention and gloss retention of coatings.

It is therefore desired in the coating industry a coating composition comprising both photocrosslinkers and inorganic pigments, with improved durability and uncompromised DPUR.

### SUMMARY OF THE INVENTION

The present invention provides an aqueous coating composition with a pigment volume concentration of from 10% to 75% comprising: i) a pigment composition comprising from 50% to 100% by weight based on the total weight of the pigment composition polymer-encapsulated pigment particles; ii) a polymer shell encapsulating the polymer-encapsulated pigment particles; and iii) from 0.1% to 2.0% by weight based on the total weight of the aqueous coating composition a photocrosslinker. The photocrosslinker is either polymerized in the polymer shell of the polymer-encapsulated pigment particles, is blended with the polymer shell of the polymer-encapsulated pigment particles, is polymerized in or blended with the copolymer of one or more additional aqueous copolymer dispersion in the coating composition, or is freely present in the aqueous coating composition outside of the polymer shell. The photocrosslinker is preferably a benzophenone derivative, a benzotriazole derivative, an acylphosphine oxide, a bisacylphosphine oxide, or the mixture thereof.

### DETAILED DESCRIPTION OF THE INVENTION

For the purpose of describing the components in the compositions of the present invention, all phrases comprising parentheses denote either or both of the included parenthetical matter and its absence. For example, the phrase “(co)polymer” includes, in the alternative, polymer, copolymer and the mixture thereof; the phrase “(meth)acrylate” means acrylate, methacrylate, and the mixture thereof.

As used herein, the term “aqueous” means water or water mixed with 50 wt % or less, based on the weight of the mixture, of water-miscible solvent.

As used herein, the term “polymer” includes resins and copolymers.

As used herein, the term “acrylic” shall mean (meth)acrylic acid, (meth)alkyl acrylate, (meth)acrylamide, (meth)acrylonitrile and modified forms thereof, such as (meth)hydroxylalkyl acrylate.

As used herein, unless otherwise indicated, the term “average particle size (or diameter)” refers to the median particle size (or diameter) of a distribution of particles as determined by electrical impedance using a MULTISIZER™ 3 Coulter Counter (Beckman Coulter, Inc., Fullerton, Calif.), per manufacturer's recommended procedures. The median is defined as the size wherein 50 wt % of the particles in the distribution are smaller than the median and 50 wt % of the particles in the distribution are larger than the median. This is a volume average particle size.

As used herein, unless otherwise indicated, the term “Tg” means glass transition temperature measured by differential scanning calorimetry (DSC) using a heating rate of 20° C./minute and taking the inflection point in the thermogram as the Tg value. The term “calculated Tg” refers to the Tg of polymers determined via the Fox equation (T. G. Fox, Bull. Am. Physics Soc., Volume 1, Issue No. 3, page 123 (1956)). The Tgs of homopolymers may be found, for example, in “Polymer Handbook”, edited by J. Brandrup and E. H. Immergut, Interscience Publishers. In the case of a multi-stage polymer, the reported Tg value shall be the weighted average of the observed inflection points in the thermogram. For example, a two stage polymer consisting of 80% soft first stage and 20% hard second stage polymer having two DSC inflection points, one at −43° C. and one at 68° C., will have a reported Tg of −20.8° C.

Pigment Composition

In the present invention, the aqueous coating composition with improved durability comprises from 1% to 50%, preferably from 2% to 30%, and more preferably from 3% to 25% by dry volume concentration based on the total dry volume of the aqueous coating composition, a pigment composition.

The pigment composition comprises from 50% to 100%, preferably from 80% to 100%, and more preferably from 95% to 100% by dry volume based on the total dry volume of the pigment composition, polymer-encapsulated pigment particles.

The pigment composition further comprises un-encapsulated pigment particles so that the total weight of the pigment particles (both encapsulated and un-capsulated) in the pigment composition reaches 100%.

As used herein, the term “pigment particles” means inorganic pigment particles, and refers to particulate inorganic materials which are capable of materially contributing to the opacity or hiding capability of a coating. Such materials typically have a refractive index of equal to or greater than 1.8 and include titanium dioxide (TiO₂), zinc oxide, zinc sulfide, barium sulfate, and barium carbonate. Titanium dioxide (TiO₂) is preferred.

The aqueous coating composition of the present invention further comprises, from 5% to 80%, preferably from 10% to 75%, more preferably from 25% to 75%, even more preferably from 40% to 75%, and most preferably from 40% to 60% by dry volume concentration based on the total dry volume of the aqueous coating composition, of extenders.

As used herein, the term “extenders” refer to a particulate inorganic materials having a refractive index of less than or equal to 1.8 and greater than 1.3 and include calcium carbonate, clay, calcium sulfate, aluminosilicate, silicate, zeolite, mica, diatomaceous earth, solid or hollow glass, and ceramic bead. The aqueous coating composition may optionally contain solid or hollow polymeric particles having a Tg of greater than 60° C., such polymeric particles are classified as extenders for purposes of pigment volume concentration (PVC) calculations herein. The details of hollow polymeric particles are described in EP 22633, EP 915108, EP 959176, EP 404184, U.S. Pat. No. 5,360,827, WO 00/68304, and US 20100063171. The solid polymeric particles have particle sizes of from 1 to 50 microns, and preferably from 5 to 20 microns.

The PVCs of the aqueous coating composition in the present invention are in a range of from 10% to 75%, preferably from 18% to 51%. As used herein, unless otherwise indicated, the term “PVC” could be calculated by the equation PVC=(volume of pigment+volume of extender)/(volume of pigment+volume of binder+volume of extender).

Polymer Shell

The polymer shell encapsulating the polymer-encapsulated pigment particles comprises at least one copolymerized ethylenically unsaturated nonionic monomer. As used herein, the term “nonionic monomer” means that the copolymerized monomer residue does not bear an ionic charge between pH=1-14. The ethylenically unsaturated nonionic monomers used in the present invention include (meth)acrylic ester monomers, where (meth)acrylic ester designates methacrylic ester or acrylic ester, including methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl methacrylate, and hydroxypropyl methacrylate; (meth)acrylonitrile; (meth)acrylamide; amino-functional and ureido-functional monomers; monomers bearing acetoacetate-functional groups; styrene and substituted styrenes; butadiene; ethylene, propylene, α-olefins such as 1-decene; vinyl acetate, vinyl butyrate, vinyl versatate and other vinyl esters; and vinyl monomers such as vinyl chloride and vinylidene chloride.

Preferably, the polymer shell encapsulating the polymer-encapsulated pigment particles further comprises from 0.1% to 10%, preferably from 0.5% to 5% by dry weight based on the total dry weight of the polymer shell, of an ethylenically unsaturated monomer carrying at least one functional group selected from carboxyl, carboxylic anhydride, hydroxyl, amide, sulphonate, phosphonate and the mixture thereof. Examples of these monomers are ethylenically unsaturated carboxylic or dicarboxylic acids, especially acrylic or methacrylic acid, itaconic acid, maleic acid, or the amides, especially N-alkylolamides or hydroxyalkyl esters of the above-mentioned carboxylic acids, such as (meth)acrylamide, N-methylol(meth)acrylamide, 2-hydroxyethyl(meth)acrylamide, hydroxyethyl (meth)acrylate, and hydroxypropyl (meth)acrylate.

The polymer shell encapsulating the polymer-encapsulated pigment particles may further comprise, in percentage by dry weight based on the total dry weight of the polymer shell, from 0.1% to 5%, preferably from 0.5% to 3%, of a surfactant, to stabilize the growing of the polymer shell during polymerization and to discourage aggregation of the polymer shell in the resulting aqueous dispersion of polymer shell and pigment particles encapsulated by the polymer shell. One or more anionic or nonionic surfactants or the mixture thereof may be used. Examples of surfactants suitable for emulsion polymerization are given in McCutcheon's Detergents and Emulsifiers (MC Publishing Co., Glen Rock, N.J.) published annually. Other types of stabilizing agents, such as protective colloids, are optionally used.

Polymer shell encapsulating the polymer-encapsulated pigment particles may also comprise other film formable polymers, such as polyurethane, epoxy resin, alkyd resin, and polyurethane-acrylic hybrid.

Preferably, the hydrophilic monomers used in the polymer shell encapsulating the polymer-encapsulated pigment particles are less than 15%, based on the total amount of the polymer shell monomers.

In one embodiment of the present invention, the polymer shell encapsulating the polymer-encapsulated pigment particles has an average thickness of from 10 to 200 nanometers, preferably from 30 to 150 nanometers, and more preferably from 40 to 120 nanometers. Scanning electron microscopy (SEM) and transmission electron microscopy (TEM) images can accurately measure the shell thickness.

In another embodiment of the present invention, the polymer shell encapsulating the said polymer-encapsulated pigment particles has a minimum film formation temperature (MFFT) of from −35° C. to 60° C., preferably from −20° C. to 40° C., and more preferably from −15° C. to 30° C. The MFFT measurement is carried out by drawing down a film of the dispersion onto a metal bar subjected to a thermal gradient and then passing dry air over the dispersion until the film is dry. The MFFT is taken to be the minimum temperature where one observes a clear and crack-free film. It is common in the coatings industry to assume that a substantial extent of polymer diffusion takes place at temperatures above but not far from the MFFT.

Conventional free radical initiators may be used in polymerization of the polymer shell. Commonly used initiators include hydrogen peroxide, sodium peroxide, potassium peroxide, t-butyl hydroperoxide, cumene hydroperoxide, ammonium and/or alkali metal persulfates, sodium perborate, perphosphoric acid and salts thereof, potassium permanganate, and ammonium or alkali metal salts of peroxydisulfuric acid. They were typically used at an amount from 0.01% to 3.0% by weight, based on the weight of total monomer. Redox systems using the same initiators coupled with a suitable reductant such as sodium sulfoxylate formaldehyde, ascorbic acid, isoascorbic acid, alkali metal and ammonium salts of sulfur-containing acids, such as sodium sulfite, bisulfite, thiosulfate, hydrosulfite, sulfide, hydrosulfide or dithionite, formadinesulfinic acid, hydroxymethanesulfonic acid, acetone bisulfite, amines such as ethanolamine, glycolic acid, glyoxylic acid hydrate, lactic acid, glyceric acid, malic acid, tartaric acid and salts of the preceding acids may be used. Redox reaction catalyzing metal salts of iron, copper, manganese, silver, platinum, vanadium, nickel, chromium, palladium, or cobalt may be used. Chelating agents for the metals may optionally be used.

Chain transfer agents may also be used in the polymerization of the polymer shell to lower the molecular weight of the emulsion polymer and/or to provide a different molecular weight distribution than would otherwise have been obtained with any free radical initiator. Suitable examples of chain transfer agents include halogen compounds such as tetrabromomethane; allyl compounds; or mercaptans such as alkyl thioglycolates, alkyl mercaptoalkanoates, and C₄-C₂₂ linear or branched alkyl mercaptans. Chain transfer agent(s) may be added in one or more additions or continuously, linearly or not, over most of or the entire reaction period or during limited portion(s) of the reaction period such as in the kettle charge and in the reduction of residual monomer stage. Chain transfer agents are typically used in the amount of 0 to 5 wt. %, based on the total weight of monomer used to form the aqueous polymer dispersion. A preferred level of chain transfer agent is from 0.01 to 0.5 mole %, preferably from 0.02 to 0.4 mole %, and more preferably from 0.05 to 0.2 mole %, based on the total moles of monomers used to form the aqueous polymer dispersion.

The polymer shell composition, particle size, particle morphology and process to make such are substantially described in for example U.S. Pat. No. 7,579,081 B2; WO 2006/037161 A1; WO 2010/074865 A1; JP 2008105919 A; and GB 2111522 A. The preparation methods of the polymer shell can be any methods familiar to one of ordinary skill in the art. General methods include emulsion polymerization, mini-emulsion polymerization, and mechanical dispersing technology. Suitable examples include those as disclosed in U.S. Pat. No. 7,579,081 B2, U.S. Pat. No. 7,357,949 B2 and WO 2010074865 A1. Preferably, the polymer shell is made by emulsion polymerization as taught in U.S. Pat. No. 7,579,081 B2 and WO 2006/037161 A1.

Additional Aqueous Copolymer Dispersion

The aqueous coating composition may also contain at least one additional aqueous copolymer dispersions with an average particle diameter of from 50 to 800 nm and a minimum film formation temperature of from −35° C. to 60° C. The additional aqueous copolymer dispersion may be present in an amount from 5% to 60%, preferably from 7% to 35%, and more preferably from 10% to 30% by dry weight based on the total dry weight of the aqueous coating composition.

The additional aqueous copolymer dispersion are copolymerized with at least one ethylenically unsaturated monomer wherein the ethylenically unsaturated monomers used in the present invention include (meth)acrylic ester monomers, where (meth)acrylic ester designates methacrylic ester or acrylic ester, including methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl methacrylate, hydroxypropyl methacrylate; (meth)acrylic acid, (meth)acrylonitrile; (meth)acrylamide; amino-functional and ureido-functional monomers; monomers bearing acetoacetate-functional groups; monomer bearing epoxy group; styrene and substituted styrenes; butadiene; ethylene, propylene, α-olefins such as 1-decene; vinyl acetate, vinyl butyrate, vinyl versatate and other vinyl esters; and vinyl monomers such as vinyl chloride, vinylidene chloride.

The glass transition temperature (Tg) of the copolymer dispersion is from −35° C. to 60° C., preferably from −15° C. to 40° C., and more preferably from −10° C. to 30° C.

The average particle diameter of the copolymer particles is from 50 to 350 nanometers, preferably from 50 to 300 nanometers, as measured by a BI-90 particle sizer. It is believed that lower particle sizes lead to greater copolymer dispersion shear instability and that larger particle sizes lead to lower binding capacity and therefore lower scrub resistance.

Photocrosslinker

The aqueous coating composition of the present invention further comprises from 0.1% to 2.0%, preferably from 0.1% to 1.5%, and more preferably from 0.3% to 1.0% by weight based on the total weight of the aqueous coating composition, of at least one photocrosslinker.

In some embodiments, the photocrosslinker used in the present invention is benzophenone (BP) derivatives, benzotriazole (BTA) derivatives, acylphosphine oxides, bisacylphosphine oxides, or the mixture thereof. In these embodiments, the photocrosslinker is blended with the polymers and copolymers including the polymer shell encapsulating the polymer-encapsulated pigment particles, and the additional copolymer dispersed in the aqueous coating composition.

Illustrative examples for benzophenone derivatives are benzophenone derivatives with one or both of the phenyl rings being substituted, and include benzophenone, 4-methyl benzophenone, 4-hydroxy benzophenone, 4-amino benzophenone, 4-chloro benzophenone, 4-hydrocarboxyl benzophenone, 4,4′-dimethyl benzophenone, 4,4′-dichloro benzophenone, 4-carboxymethyl benzophenone, 3-nitro benzophenone. A preferred example is benzophenone or a 4-substituted (para-) benzophenone. Benzophenone is more preferred.

Illustrative examples for benzotriazole derivatives include 1,2-(2′-hydroxyphenyl)benzotriazoles such as 2-(2′-hydroxy-5′-methylphenyl)benzotriazole, 2-(3′,5′-di-tert-butyl-2′-hydroxyphenyl) benzotriazole, 2(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphen-yl)-5-chlorobenzotriazole, 2-(3′-sec-butyl-5′-tert-butyl-2′-hydroxyphenyl)benzotriazole, 2-(2′-hydroxy-4′-octoxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)-benzotriazole, mixture of 2-(3′-tert-butyl-2′-hydroxy-5′-(2-octyloxycarbonylethyl)phenyl)-5-chlorobenzotriazole, 2-(3′-tert-butyl-5′-[2-(2-ethyl-hexyl-oxy)carbonylethyl]-2′-hydroxyphenyl)-5-chlorobenzotriazole, 2-(3′-tert-butyl-2′-hy-droxy-5′-(2-methoxycarbonylethyl)phenyl)-5-chlorobenzotriazole, 2-(3′-tert-butyl-2′-hydroxy-5′-(2-methoxycarbonylethyl)phenyl)-benzotriazole, 2-(3′-tert-butyl-2′-hydroxy-5′-(2-octyloxy-carbonylethyl)phenyebenzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, and 2,2′-methylene-bis[4-(1,1,3,3-tetramethylbutyl)-6-benzotriazol-2-yl-phenol]; transesterification product of 2-[3′-tert-butyl-5′-(2-methoxycarbonylethyl)-2′-hydroxy-phenyl]-benzotriazole with polyethylene glycol 300; and [R-CH₂—CH₂—COO(CH₂)₃]₂-where R=3′-tert-butyl-4′-hydroxy-5′-2H-benzotriazol-2-yl-phenyl.

Illustrative examples for acylphosphine oxides include 2,6-dimethylbenzoyldiphenyl phosphine oxide, 2,4,6-trimethylbenzoyldiphenylphosphine oxide, bis(2,4,6-trimethylbenzoyl)phenyl phosphine oxide, 2,6-dichlorobenzoyl-diphenylphosphine oxide, and 2,6-dimethoxybenzoyldiphenylphosphine oxide.

Illustrative examples for bisacylphosphine oxides include bis(2,6-dimethyoxybenzoyl)-2,4,4-trimethylepentylphosphine oxide, bis(2,6-dimethylbenzoyl)-2,4,4-trimethylpentylphosphine oxide, his (2,4,6-trimethylbenzoyl)-2,4,4-trimethylpentylphosphine oxide, and bis(2,6-dichlorobenzoyl)-2,4,4-trimethylpentylphosphine oxide.

In other embodiments, photocrosslinkers modified with ethylenically unsaturated functional group can also be used in the present invention. In these embodiments, photocrosslinkers are polymerized in the polymers/copolymers including the polymer shell encapsulating the polymer-encapsulated pigment particles, and the additional copolymer dispersed in the aqueous coating composition.

Photocrosslinkers modified with ethylenically unsaturated functional group can be easily synthesized by ordinary techniques in the art. Illustrative examples of photocrosslinkers modified with ethylenically unsaturated function group include 4-vinyl-4′-methoxy benzophenone, 2-methyl-4′-vinyl benzophenone and 4-vinyl benzophenone.

The photocrosslinker of the present invention may be polymerized or blended in the polymer shell encapsulating the polymer-encapsulated pigment particles, or in copolymer of at least one additional aqueous copolymer dispersions in the coating composition, or is freely present in the aqueous coating composition outside of the polymer shell or the copolymer.

As used herein, the term “free” or “freely present” means photocrosslinker is added to water phase in certain method rather than in polymer particles of the dispersion. For example, photocrosslinker may be first dissolved in an acetone and then the solution is added into the aqueous coating composition.

Theoretically, all photocrosslinkers disclosed in the present invention could be freely present in the aqueous coating composition. Preferably, the photocrosslinker without modification is freely present in the aqueous coating composition. Preferably, the photocrosslinker is blended in the polymer shell encapsulating the polymer-encapsulated pigment particles, or in copolymer of at least one additional aqueous copolymer dispersions in the coating composition.

Other Coating Additives

The aqueous coating composition of the present invention may contain at least one conventional coating additives including coalescing agents, cosolvents, surfactants, buffers, neutralizers, thickeners, non-thickening rheology modifiers, dispersants, humectants, wetting agents, mildewcides, biocides, plasticizers, antifoaming agents, defoaming agents, anti-skinning agents, colorants, flowing agents, crosslinkers, and anti-oxidants.

Thickeners may include polyvinyl alcohol (PVA), hydrophobically modified alkali soluble emulsions (HASE), alkali-soluble or alkali swellable emulsions (ASE), hydrophobically modified ethylene oxide-urethane polymers known in the art as HEUR, and cellulosic thickeners such as hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, 2-hydoxypropyl cellulose. Fumed silica, attapulgite clay and other types of clay, and titanate chelating agents could also be useful.

Dispersants may include non-ionic, anionic and cationic dispersants such as polyacid with suitable molecular weight, 2-amino-2-methyl-1-propanol (AMP), dimethyl amino ethanol (DMAE), potassium tripolyphosphate (KTPP), trisodium polyphosphate (TSPP), citric acid and other carboxylic acids. Prefer the polyacids with suitable molecular weight. The polyacids may be homopolymers and copolymers based on polycarboxylic acids, including those that have been hydrophobically or hydrophilically modified, e.g., polyacrylic acid or polymethacrylic acid or maleic anhydride with various monomers such as styrene, acrylate or methacrylate esters, diisobutylene, and other hydrophilic or hydrophobic comonomers as well as the salts of the aforementioned dispersants, and mixtures thereof. The molecular weight of such polyacids dispersant is from 400 to 50,000, from 400 to 30,000, preferably from 500 to 10,000, more preferably from 1,000 to 5,000, and most preferably from 1,500 to 3,000.

Antifoaming agents or defoaming agents may include silicone-based and mineral oil-based defoamers. Surfactants may include anionic, nonionic, cationic surfactants and amphiphilic surfactant. Anionic and nonionic surfactants are preferred, and nonionic surfactant is even more preferred.

Suitable coalescing agents, plasticizers, and other optional cosolvents may include ethylene glycol, propylene glycol, hexylene glycol, 2,2,4-trimethyl-1,3-pentanediol monoisobutyrate (TEXANOL™), Coasol™ coalescent, glycol ethers, mineral spirits, methyl carbitol, butylcarbitol, phthalates, and adipates.

Method of Preparation of the Aqueous Coating Composition

The preparation of the aqueous coating composition involves the process of selecting and admixing appropriate coating ingredients in the correct proportions to provide a coating with specific processing and handling properties, as well as a final dry coating film with the desired properties.

Method of Using the Aqueous Coating Composition

The aqueous coating composition may be applied by conventional application methods such as brushing, roller application, and spraying methods such as air-atomized spray, air-assisted spray, airless spray, high volume low pressure spray, and air-assisted airless spray.

Suitable substrates include concrete, cement board, medium-density fiberboard (MDF) and particle board, gypsum board, wood, stone, metal, plastics, wall paper and textile, etc. Preferably, all the substrates are pre-primed by waterborne or solvent borne primers.

### EXAMPLES

### I. Raw Materials

TABLE 1
A) Monomers used in making polymer compound

| Compound | Chemical Nature |
|---|---|
| BA | butyl acrylate |
| ST | Styrene |
| MMA | methyl methacrylate |
| MAA | methacrylic acid |
| EHA | ethyl hexyl acrylate |
| AM | Acrylamide |

B) Starting materials used in the aqueous coating composition

| Material | Available from |
|---|---|
| KATHON ™ LXE biocide | The Dow Chemical Company |
| ROCIMA ™ 361 biocide | The Dow Chemical Company |
| NATROSOL ™ 250 HBR thickener | Ashland Aqualon Company |
| NATROSOL ™ 250 MBR thickener | Ashland Aqualon Company |
| propylene glycol | Sinopharm Chemical Reagent Co., Ltd. |
| AMP 95 base | The Dow Chemical Company |
| OROTAN ™ 731A dispersant | The Dow Chemical Company |
| OROTAN ™ 1124 dispersant | The Dow Chemical Company |
| OROTAN ™ 1288 dispersant | The Dow Chemical Company |
| TRITON ™ BD-405 wetting agent | The Dow Chemical Company |
| TRITON ™ EF-106 wetting agent | The Dow Chemical Company |
| TRITON ™ CF-10 wetting agent | Union Carbide Corporation |
| NOPCO ™ NXZ defoamer | Nopco Chemicals Co. Ltd. |
| TEGO ™ Foamex 825 defoamer | Evonik Degussa Corporation |
| BYK ™ 022 defoamer | BYK-Chemie GmbH |
| TI-PURE ™ R-706 pigment | E. I. du Pont de Nemours and Company |
| CC-700 extender | Guangfu Building Materials Group |
| | (China) |
| CC-1000 extender | Guangfu Building Materials Group |
| | (China) |
| DB-80 extender | Guangfu Building Materials Group |
| | (China) |
| ROPAQUE ™ Ultra E opaque polymer | The Dow Chemical Company |
| COASOL ™ coalescent | The Dow Chemical Company |
| TEXANOL ™ coalescent | Eastman Chemical Company |
| PRIMAL ™ TT-935 rheology modifier | The Dow Chemical Company |
| PRIMAL ™ SCT-275 rheology modifier | The Dow Chemical Company |
| ACRYSOL ™ RM-2020 NPR rheology modifier | The Dow Chemical Company |
| ACRYSOL ™ RM-8W rheology modifier | The Dow Chemical Company |
| benzophenone (BP) | Sinopharm Chemical Reagent Co., Ltd. |
| diphenyl (2,4,6-trimethylbenzoyl) phosphine | Sinopharm Chemical Reagent Co., Ltd. |
| oxide (TPO) | |
| benzotriazole (BTA) | Tokyo Chemical Industry Co., Ltd. |
| acetone | Sinopharm Chemical Reagent Co., Ltd. |
| 888-7214 COLORTREND ™ PHTHALO BLUE | Evonik Degussa Corporation |
| E. colorant (888-7214) | |
| 896-7210 CHROMA-CHEM ™ PHTHALO | Evonik Degussa Corporation |
| BLUE GS. Colorant (896-7210) | |

### II. Test Procedures

a) Accelerated Durability Test

Gloss retention (%) and color change (AE) were used as indicators of coating durability. To test coating durability, an aluminum plate was coated by a coating composition followed by drying for seven days in a constant temperature room (CTR, 25° C., 50% relative humidity (“R.H.”)). To test color change, an aluminum plate was coated by a coating composition mixed with 4 wt. % blue colorant (888-7214 COLORTREND™ PHTALO BLUE E. colorant) followed by drying for seven days in a constant temperature room (CTR, 25° C., 50% R.H.). The aluminum plate was put into a QUV/Se QUV Accelerated Weathering Tester (Q-Lab Corporation, 340 nm light source UVA, 60±3° C. black-panel temperature, and 0.68 w/m² irradiance intensity) for accelerated durability test. After multiple cycles (lasting for 900 hours or 1500 hours) of a 4-hr ultraviolet irradiation followed by a 4-hr condensation, the aluminum plate was taken out and cooled to room temperature. Gloss retention (%) and color change (ΔE) of the coating film were respectively measured by a micro-TRI-gloss Gloss Meter (BYK-Gardner) and a Spectro-guide Sphere Gloss Portable Spectrophotometers (BYK-Gardner) before and after the accelerated durability test. A higher gloss retention or smaller color change represented better coating durability.

b) DPUR Test

A reflectance Y value was used as an indication of coating DPUR. Two methods were used to test the Y values: one was a long term DPUR test, and the other was an accelerated in-lab DPUR test.

Long Term DPUR Test:

Two 15 mil thick wet coating films were brushed on a cement panel followed by drying it for seven days in a constant temperature room (CTR, 25° C., 50% R.H.). The panel was exposed to the south at a 45 degree angle in Shanghai, China for 4 months starting from November. The initial and final values of reflectance Y were measured by a Spectro-guide Sphere Gloss Portable Spectrophotometers. A smaller change of the reflectance Y values indicated a better DPUR.

Accelerated In-Lab DPUR Test:

A 100 μm thick wet coating film was applied on a cement panel and the panel was dried under the ambient condition for 4 hours followed by further applied with an 80 μm thick wet coating film. After being dried for 7 days, the cement panel was irradiated by an ultraviolet light for 3 hours, and the initial reflectance Y value was measured by a Spectro-guide Sphere Gloss Portable Spectrophotometers. Formulated ash (0.7±0.1 g, 52.6 wt. %, YouTu Instrument Company, China) was mixed with water and then brushed on the coating film. The panel was dried for 2 hours under the ambient condition. Test panels were washed in maximum flow evenly for 1 min and dried overnight. The ash loading and washing off procedure were repeated for 5 times. The final reflectance Y was measured by the same Spectro-guide Sphere Gloss Portable Spectrophotometers. A smaller change of the reflectance Y values indicated a better DPUR.

### III. Experimental Examples

### Example 1

### Compositions of the Polymer Shell Encapsulating the Polymer-Encapsulated Pigment Particles (for Convenience, the Polymer Shell and the Encapsulated Pigment as a Whole is Named as a Composite Hereinafter)

TABLE 2

| | | Dispersion characteristics | | | |
|---|---|---|---|---|---|
| Composite | | WS^{a} | PLT^{b} | PVC^{c} | MFFT^{d} |
| ID | Polymer shell | (%) | (nm) | (%) | (° C.) |
| 1 | 57BA/42MMA/1.0AM | 59 | 85 | 26.4 | 8 |
| 2 | 50BA/48MMA/2MAA | 60 | 85 | 26.4 | 18 |
| 3 | 45ST/43BA/10MMA/2MAA | 59 | 85 | 26.4 | 30 |

The polymer-encapsulated pigment particles are TI-PURE ™ R-706
^{a}WS = weight solids
^{b}PLT = polymer layer thickness
^{c}PVC = pigment volume concentration
^{d}MFFT = minimum film formation temperature (of polymer)

### Example 2

### Compositions of the Additional Aqueous Copolymer Dispersions

TABLE 3

| | | Dispersion characteristics | | | |
|---|---|---|---|---|---|
| Dispersant | | WS | PS^{e} | | MFFT |
| ID | Copolymer | (%) | (nm) | pH^{f} | (° C.) |
| 1 | 23BA/47.3MMA/27EHA/ | 45 | 130 | 8.5 | 8 |
| | 2.7MAA | | | | |
| 2 | 45.5BA/52.5MMA/2MAA | 50 | 130 | 8.8 | 18 |
| 3 | 61ST/37BA/2AA | 50 | 140 | 8.5 | 30 |

^{e}PS = particle size
^{f}pH = pH of the dispersion after neutralization

### Example 3

### The aqueous Coating Compositions

Grind is the first stage in coating preparation where powders like pigment, extenders were dispersed in water to make an aqueous dispersion. Let down is the second stage where ingredients in dispersions or solutions were added to make a final coating.

Coating 1

A coating containing an aqueous dispersion of the polymer-encapsulated pigment particles was prepared using the following procedure to form the aqueous coating composition (Coating 1). The ingredients listed in Table 4 (let down) were added using a conventional lab mixer. The PVC of the resulting coating was 18%. The benzophenone (BP) level was 2.0% based on the total wet weight of the formulation.

TABLE 4
18% PVC Aqueous Coating Composition

| | |
|---|---|
| Material | Weight (g) |

Coating 1 formulation

| | |
|---|---|
| Let down | |
| Composite 2 | 650.17 |
| Copolymer dispersion 2 | 206.00 |
| propylene glycol | 20.00 |
| TRITON ™ BD-405 wetting agent | 2.00 |
| NOPCO ™ NXZ defoamer | 2.00 |
| COASOL ™ coalescent | 27.01 |
| ACRYSOL ™ RM-2020 NPR rheology modifier | 4.20 |
| ACRYSOL ™ RM-8W rheology modifier | 3.18 |
| AMP 95 | 0.36 |
| water | 45.08 |
| benzophenone (BP) | 20.00 |
| acetone | 20.00 |
| Total | 1000.00 |

Coating 1 characteristics

| | |
|---|---|
| Total PVC | 18% |
| BP level | 2.0% |

Coating 2 (Comparative Example)

A coating containing no polymer-encapsulated pigment particles was prepared using the following procedure to form the aqueous coating composition (Coating 2). The ingredients listed in Table 5 (grind) were mixed using a high speed Cowles disperser. The ingredients listed in Table 5 (let down) were added using a conventional lab mixer. The PVC of the resulting coating was 18%. The BP level was 2.0% based on the total wet weight of the formulation.

TABLE 5
18% PVC Aqueous Coating Composition

| | |
|---|---|
| Material | Weight (g) |

Coating 2 formulation

| | |
|---|---|
| Grind | |
| Water | 90.00 |
| OROTAN ™ 731A dispersant | 6.72 |
| NOPCO ™ NXZ defoamer | 1.00 |
| TI-PURE ™ R-706 pigment | 210.00 |
| Let down | |
| Copolymer dispersion 2 | 540.00 |
| propylene glycol | 20.00 |
| TRITON ™ BD-405 wetting agent | 2.00 |
| NOPCO ™ NXZ defoamer | 1.00 |
| COASOL ™ coalescent | 27.00 |
| ACRYSOL ™ RM-2020 NPR rheology modifier | 4.60 |
| ACRYSOL ™ RM-8W rheology modifier | 2.42 |
| AMP 95 | 0.58 |
| water | 54.68 |
| BP | 20.00 |
| acetone | 20.00 |
| Total | 1000.00 |

Coating 2 characteristics

| | |
|---|---|
| Total PVC | 18% |
| BP level | 2.0% |

Coating 3

A coating containing an aqueous dispersion of the polymer-encapsulated pigment particles was prepared using the following procedure to form the aqueous coating composition (Coating 3). The ingredients listed in Table 6 (let down) were added using a conventional lab mixer. The PVC of the resulting coating was 18%. The BP level was 1.0% based on the total wet weight of the formulation.

TABLE 6
18% PVC Aqueous Coating Composition

| | |
|---|---|
| Material | Weight (g) |

Coating 3 formulation

| | |
|---|---|
| Let down | |
| Composite 2 | 650.17 |
| Copolymer dispersion 2 | 206.00 |
| propylene glycol | 20.00 |
| TRITON ™ BD-405 wetting agent | 2.00 |
| NOPCO ™ NXZ defoamer | 2.00 |
| COASOL ™ coalescent | 27.01 |
| ACRYSOL ™ RM-2020 NPR rheology modifier | 4.20 |
| ACRYSOL ™ RM-8W rheology modifier | 3.18 |
| AMP 95 | 0.36 |
| water | 65.08 |
| BP | 10.00 |
| acetone | 10.00 |
| Total | 1000.00 |

Coating 3 characteristics

| | |
|---|---|
| Total PVC | 18% |
| BP level | 1.0% |

Coating 4 (Comparative Example)

A coating containing no polymer-encapsulated pigment particles was prepared using the following procedure to form the aqueous coating composition (Coating 4). The ingredients listed in Table 7 (grind) were mixed using a high speed Cowles disperser. The ingredients listed in Table 7 (let down) were added using a conventional lab mixer. The PVC of the resulting coating was 18%. The BP level was 1.0% based on the total wet weight of the formulation.

TABLE 7
18% PVC Aqueous Coating Composition

| | |
|---|---|
| Material | Weight (g) |

Coating 4 formulation

| | |
|---|---|
| Grind | |
| Water | 90.00 |
| OROTAN ™ 731A dispersant | 6.72 |
| NOPCO ™ NXZ defoamer | 1.00 |
| TI-PURE ™ R-706 pigment | 210.00 |
| Let down | |
| Copolymer dispersion 2 | 540.00 |
| propylene glycol | 20.00 |
| TRITON ™ BD-405 wetting agent | 2.00 |
| NOPCO ™ NXZ defoamer | 1.00 |
| COASOL ™ coalescent | 27.00 |
| ACRYSOL ™ RM-2020 NPR rheology modifier | 4.60 |
| ACRYSOL ™ RM-8W rheology modifier | 2.42 |
| AMP 95 | 0.58 |
| water | 74.68 |
| BP | 10.00 |
| acetone | 10.00 |
| Total | 1000.00 |

Coating 4 characteristics

| | |
|---|---|
| Total PVC | 18% |
| BP level | 1.0% |

Coating 5

A coating containing an aqueous dispersion of the polymer-encapsulated pigment particles was prepared using the following procedure to form the aqueous coating composition (Coating 5). The ingredients listed in Table 8 (let down) were added using a conventional lab mixer. The PVC of the resulting coating was 25%. The BP level was 0.15% based on the total wet weight of the formulation.

TABLE 8
25% PVC Aqueous Coating Composition

| | |
|---|---|
| Material | Weight (g) |

Coating 5 formulation

| | |
|---|---|
| Let down | |
| Composite 1 | 720.34 |
| Copolymer dispersion 1 | 129.40 |
| ROPAQUE ™ Ultra E opaque polymer | 40.00 |
| propylene glycol | 20.00 |
| NOPCO ™ NXZ defoamer | 2.00 |
| COASOL ™ coalescent | 8.09 |
| ACRYSOL ™ RM-2020 NPR rheology modifier | 4.08 |
| PRIMAL ™ SCT-275 rheology modifier | 7.13 |
| AMP 95 | 1.44 |
| BP | 1.5 |
| acetone | 1.5 |
| water | 64.52 |
| Total | 1000 |

Coating 5 characteristics

| | |
|---|---|
| Total PVC | 25% |
| BP level | 0.15% |

Coating 6 (Comparative Example)

A coating containing no polymer-encapsulated pigment particles was prepared using the following procedure to form the aqueous coating composition (Coating 6). The ingredients listed in Table 9 (grind) were mixed using a high speed Cowles disperser. The ingredients listed in Table 9 (let down) were added using a conventional lab mixer. The PVC of the resulting coating was 25%. The BP level was 0.15% based on the total wet weight of the formulation.

TABLE 9
25% PVC Aqueous Coating Composition

| | |
|---|---|
| Material | Weight (g) |

Coating 6 formulation

| | |
|---|---|
| Grind | |
| Water | 80.00 |
| propylene glycol | 10.00 |
| OROTAN ™ 731A dispersant | 6.72 |
| NOPCO ™ NXZ defoamer | 1.00 |
| TI-PURE ™ R-706 pigment | 210.00 |
| Let down | |
| Copolymer dispersion 1 | 540 |
| ROPAQUE ™ Ultra E opaque polymer | 40.00 |
| propylene glycol | 10.00 |
| NOPCO ™ NXZ defoamer | 1.00 |
| COASOL ™ coalescent | 7.73 |
| ACRYSOL ™ RM-2020 NPR rheology modifier | 4.05 |
| PRIMAL ™ SCT-275 rheology modifier | 4.35 |
| AMP 95 | 1.35 |
| BP | 1.5 |
| acetone | 1.5 |
| water | 80.8 |
| Total | 1000 |

Coating 6 characteristics

| | |
|---|---|
| Total PVC | 25% |
| BP level | 0.15% |

Coating 7

A coating containing an aqueous dispersion of the polymer-encapsulated pigment particles was prepared using the following procedure to form the aqueous coating composition (Coating 7). The ingredients listed in Table 10 (grind) were mixed using a high speed Cowles disperser. The ingredients listed in Table 10 (let down) were added using a conventional lab mixer. The PVC of the resulting coating was 51%. The BP level was 0.08% based on the total wet weight of the formulation.

TABLE 10
51% PVC Aqueous Coating Composition

| | |
|---|---|
| Material | Weight (g) |

Coating 7 formulation

| | |
|---|---|
| Grind | |
| Water | 90.00 |
| propylene glycol | 15.00 |
| NATROSOL ™ 250 HBR thickener | 2.00 |
| AMP 95 | 1.00 |
| NOPCO ™ NXZ defoamer | 1.00 |
| TRITON ™ BD-405 wetting agent | 2.00 |
| OROTAN ™ 1124 dispersant | 3.23 |
| KATHON ™ LXE biocide | 1.00 |
| ROCIMA ™ 361 biocide | 7.00 |
| CC-700 | 145.00 |
| DB-80 | 70.00 |
| Let down | |
| Composite 1 | 520.12 |
| Copolymer dispersion 2 | 50.00 |
| ROPAQUE ™ Ultra E opaque polymer | 50.00 |
| COASOL ™ coalescent | 22.55 |
| NOPCO ™ NXZ defoamer | 1.00 |
| PRIMAL ™ TT-935 rheology modifier | 1.20 |
| ACRYSOL ™ RM-2020 NPR rheology modifier | 5.20 |
| AMP 95 | 1.30 |
| BP | 0.80 |
| acetone | 0.80 |
| water | 9.80 |
| Total | 1000 |

Coating 7 characteristics

| | |
|---|---|
| Total PVC | 51% |
| BP level | 0.08% |

Coating 8 (Comparative Example)

A coating containing no polymer-encapsulated pigment particles was prepared using the following procedure to form the aqueous coating composition (Coating 8). The ingredients listed in Table 11 (grind) were mixed using a high speed Cowles disperser. The ingredients listed in Table 11 (let down) were added using a conventional lab mixer. The PVC of the resulting coating was 51%.The BP level was 0.08% based on the total wet weight of the formulation.

TABLE 11
51% PVC Aqueous Coating Composition

| | |
|---|---|
| Material | Weight (g) |

Coating 8 formulation

| | |
|---|---|
| Grind | |
| water | 140.00 |
| propylene glycol | 15.00 |
| NATROSOL ™ 250 HBR thickener | 2.00 |
| AMP 95 | 1.00 |
| NOPCO ™ NXZ defoamer | 1.00 |
| TRITON ™ BD-405 wetting agent | 2.00 |
| OROTAN ™ 1124 dispersant | 5.85 |
| KATHON ™ LXE biocide | 1.00 |
| ROCIMA ™ 361 biocide | 7.00 |
| TI-PURE ™ R-706 pigment | 210.00 |
| CC-700 | 120.00 |
| DB-80 | 60.00 |
| Let down | |
| Copolymer dispersion 2 | 314.00 |
| ROPAQUE ™ Ultra E opaque polymer | 50.00 |
| COASOL ™ coalescent | 17.20 |
| NOPCO ™ NXZ defoamer | 1.00 |
| PRIMAL ™ TT-935 rheology modifier | 1.20 |
| ACRYSOL ™ RM-2020 NPR rheology modifier | 5.20 |
| AMP 95 | 1.28 |
| BP | 0.79 |
| acetone | 0.79 |
| water | 43.69 |
| Total | 1000 |

Coating 8 characteristics

| | |
|---|---|
| Total PVC | 51% |
| BP unit level | 0.08% |

Coating 9

A coating containing an aqueous dispersion of the polymer-encapsulated pigment particles was prepared using the following procedure to form the aqueous coating composition (Coating 9). The ingredients listed in Table 12 (grind) were mixed using a high speed Cowles disperser. The ingredients listed in Table 12 (let down) were added using a conventional lab mixer. The PVC of the resulting coating was 75%. The BP level was 0.1% based on the total wet weight of the formulation.

TABLE 12
75% PVC Aqueous Coating Composition

| | |
|---|---|
| Material | Weight (g) |

Coating 9 formulation

| | |
|---|---|
| Grind | |
| water | 220.00 |
| propylene glycol | 15.00 |
| NATROSOL ™ 250 HBR thickener | 2.00 |
| AMP 95 | 1.00 |
| NOPCO ™ NXZ defoamer | 1.00 |
| TRITON ™ BD-405 wetting agent | 2.00 |
| OROTAN ™ 1288 dispersant | 5.80 |
| CC-700 | 260.00 |
| DB-80 | 90.00 |
| Let down | |
| Composite 2 | 255.43 |
| Copolymer dispersion 2 | 2.70 |
| ROPAQUE ™ Ultra E opaque polymer | 50.00 |
| NOPCO ™ NXZ defoamer | 1.00 |
| COASOL ™ coalescent | 9.84 |
| PRIMAL ™ TT-935 rheology modifier | 7.20 |
| ACRYSOL ™ RM-2020 NPR rheology modifier | 6.00 |
| AMP 95 | 1.30 |
| water | 67.73 |
| BP | 1.00 |
| acetone | 1.00 |
| Total | 1000.00 |

Coating 9 characteristics

| | |
|---|---|
| Total PVC | 75% |
| BP level | 0.1% |

Coating 10 (Comparative Example)

A coating containing no polymer-encapsulated pigment particles was prepared using the following procedure to form the aqueous coating composition (Coating 10). The ingredients listed in Table 13 (grind) were mixed using a high speed Cowles disperser. The ingredients listed in Table 13 (let down) were added using a conventional lab mixer. The PVC of the resulting coating was 75%.The BP level was 0.1% based on the total wet weight of the formulation.

TABLE 13
75% PVC Aqueous Coating Composition

| | |
|---|---|
| Material | Weight (g) |

Coating 10 formulation

| | |
|---|---|
| Grind | |
| water | 290.00 |
| propylene glycol | 15.00 |
| NATROSOL ™ 250 HBR thickener | 2.00 |
| AMP 95 | 1.00 |
| NOPCO ™ NXZ defoamer | 1.00 |
| TRITON ™ BD-405 wetting agent | 2.00 |
| OROTAN ™ 1288 dispersant | 7.33 |
| TI-PURE ™ R-706 pigment | 110.00 |
| CC-700 | 240.00 |
| DB-80 | 90.00 |
| Let down | |
| Copolymer dispersion 2 | 134.00 |
| ROPAQUE ™ Ultra E opaque polymer | 50.00 |
| NOPCO ™ NXZ defoamer | 1.00 |
| COASOL ™ coalescent | 9.84 |
| PRIMAL ™ TT-935 rheology modifier | 3.51 |
| ACRYSOL ™ RM-2020 NPR rheology modifier | 6.00 |
| water | 35.32 |
| BP | 1.00 |
| acetone | 1.00 |
| Total | 1000.00 |

Coating 10 characteristics

| | |
|---|---|
| Total PVC | 75% |
| BP level | 0.1% |

Coating 11 (Comparative Example)

A coating containing 1 part of the polymer-encapsulated pigment particles, and 9 parts of the un-encapsulated pigment particles was prepared using the following procedure to form the aqueous coating composition (Coating 11). The ingredients listed in Table 14 (grind) were mixed using a high speed Cowles disperser. The ingredients listed in Table 14 (let down) were added using a conventional lab mixer. The PVC of the resulting coating was 18%. The BP level was 0.27% based on the total wet weight of the formulation.

TABLE 14
18% PVC Aqueous Coating Composition

| | |
|---|---|
| Material | Weight (g) |

Coating 11 formulation

| | |
|---|---|
| Grind | |
| Water | 81.00 |
| Orotan ™ 731A | 6.05 |
| NOPCO ™ NXZ defoamer | 0.90 |
| TI-PURE ™ R-706 pigment | 189.00 |
| Let down | |
| Composite 2 | 65.02 |
| Copolymer dispersion 2 | 506.59 |
| propylene glycol | 20.00 |
| TRITON ™ BD-405 wetting agent | 2.00 |
| NOPCO ™ NXZ defoamer | 1.10 |
| COASOL ™ coalescent | 27.00 |
| ACRYSOL ™ RM-2020 NPR rheology modifier | 4.20 |
| ACRYSOL ™ RM-8W rheology modifier | 3.08 |
| AMP 95 | 0.30 |
| water | 88.36 |
| BP | 2.7 |
| acetone | 2.7 |
| Total | 1000.00 |

Coating 11 characteristics

| | |
|---|---|
| Total PVC | 18.04% |
| BP level | 0.27% |

Coating 12

A coating containing 3 parts of the polymer-encapsulated pigment particles and 7 parts of the un-encapsulated pigment particles was prepared using the following procedure to form the aqueous coating composition (Coating 12). The ingredients listed in Table 15 (grind) were mixed using a high speed Cowles disperser. The ingredients listed in Table 15 (let down) were added using a conventional lab mixer. The PVC of the resulting coating was 18%. The BP level was 0.27% based on the total wet weight of the formulation.

TABLE 15
18% PVC Aqueous Coating Composition

| | |
|---|---|
| Material | Weight (g) |

Coating 12 formulation

| | |
|---|---|
| Grind | |
| water | 63.00 |
| OROTAN ™ 731A dispersant | 4.70 |
| NOPCO ™ NXZ defoamer | 0.70 |
| TI-PURE ™ R-706 pigment | 147.00 |
| Let down | |
| Composite 2 | 195.05 |
| Copolymer dispersion 2 | 440.00 |
| propylene glycol | 20.00 |
| TRITON ™ BD-405 wetting agent | 2.00 |
| NOPCO ™ NXZ defoamer | 1.30 |
| COASOL ™ coalescent | 27.01 |
| ACRYSOL ™ RM-2020 NPR rheology modifier | 4.20 |
| ACRYSOL ™ RM-8W rheology modifier | 3.18 |
| AMP 95 | 0.36 |
| water | 86.1 |
| BP | 2.7 |
| acetone | 2.7 |
| Total | 1000.00 |

Coating 12 characteristics

| | |
|---|---|
| Total PVC | 18% |
| BP level | 0.27% |

Coating 13

A coating containing 5 parts of the polymer-encapsulated pigment particles and 5 parts of the un-encapsulated pigment particles was prepared using the following procedure to form the aqueous coating composition (Coating 13). The ingredients listed in Table 16 (grind) were mixed using a high speed Cowles disperser. The ingredients listed in Table 16 (let down) were added using a conventional lab mixer. The PVC of the resulting coating was 18%. The BP level was 0.27% based on the total wet weight of the formulation.

TABLE 16
18% PVC Aqueous Coating Composition

| | |
|---|---|
| Material | Weight (g) |

Coating 13 formulation

| | |
|---|---|
| Grind | |
| Water | 45.00 |
| OROTAN ™ 731A dispersant | 3.36 |
| NOPCO ™ NXZ defoamer | 0.50 |
| TI-PURE ™ R-706 pigment | 105.00 |
| Let down | |
| Composite 2 | 325.07 |
| Copolymer dispersion 2 | 372.92 |
| propylene glycol | 20.00 |
| TRITON ™ BD-405 wetting agent | 2.00 |
| NOPCO ™ NXZ defoamer | 1.50 |
| COASOL ™ coalescent | 27.00 |
| ACRYSOL ™ RM-2020 NPR rheology modifier | 4.50 |
| ACRYSOL ™ RM-8W rheology modifier | 3.08 |
| AMP 95 | 0.56 |
| water | 84.2 |
| BP | 2.7 |
| acetone | 2.7 |
| Total | 1000.00 |

Coating 13 characteristics

| | |
|---|---|
| Total PVC | 18% |
| BP | 0.27% |

Coating 14

A coating containing an aqueous dispersion of the polymer-encapsulated pigment particles was prepared using the following procedure to form the aqueous coating composition (Coating 14). The ingredients listed in Table 17 (let down) were added using a conventional lab mixer. The PVC of the resulting coating was 18%. The BTA level was 1.0% based on the total wet weight of the formulation.

TABLE 17
18% PVC Aqueous Coating Composition

| | |
|---|---|
| Material | Weight (g) |

Coating 14 formulation

| | |
|---|---|
| Let down | |
| Composite 2 | 650.17 |
| Copolymer dispersion 2 | 206.00 |
| propylene glycol | 20.00 |
| TRITON ™ BD-405 wetting agent | 2.00 |
| NOPCO ™ NXZ defoamer | 2.00 |
| COASOL ™ coalescent | 27.01 |
| ACRYSOL ™ RM-2020 NPR rheology modifier | 4.20 |
| ACRYSOL ™ RM-8W rheology modifier | 3.18 |
| AMP 95 | 0.36 |
| water | 65.08 |
| BTA | 10.00 |
| acetone | 10.00 |
| Total | 1000.00 |

Coating 14 characteristics

| | |
|---|---|
| Total PVC | 18% |
| BTA level | 1.0% |

Coating 15 (Comparative Example)

A coating containing no polymer-encapsulated pigment particles was prepared using the following procedure to form the aqueous coating composition (Coating 15). The ingredients listed in Table 18 (grind) were mixed using a high speed Cowles disperser. The ingredients listed in Table 18 (let down) were added using a conventional lab mixer. The PVC of the resulting coating was 18%.The BTA level was 1.0% based on the total wet weight of the formulation.

TABLE 18
18% PVC Aqueous Coating Composition

| | |
|---|---|
| Material | Weight (g) |

Coating 16 formulation

| | |
|---|---|
| Grind | |
| water | 90.00 |
| OROTAN ™ 731A dispersant | 6.72 |
| NOPCO ™ NXZ defoamer | 1.00 |
| TI-PURE ™ R-706 pigment | 210.00 |
| Let down | |
| Copolymer dispersion 2 | 540.00 |
| propylene glycol | 20.00 |
| TRITON ™ BD-405 wetting agent | 2.00 |
| NOPCO ™ NXZ defoamer | 1.00 |
| COASOL ™ coalescent | 27.00 |
| ACRYSOL ™ RM-2020 NPR rheology modifier | 4.60 |
| ACRYSOL ™ RM-8W rheology modifier | 2.42 |
| AMP 95 | 0.58 |
| water | 74.68 |
| BTA | 10.00 |
| acetone | 10.00 |
| Total | 1000.00 |

Coating 15 characteristics

| | |
|---|---|
| Total PVC | 18% |
| BTA level | 1.0% |

Coating 16

A coating containing an aqueous dispersion of the polymer-encapsulated pigment particles was prepared using the following procedure to form the aqueous coating composition (Coating 16). The ingredients listed in Table 20 (let down) were added using a conventional lab mixer. The PVC of the resulting coating was 18%. The TPO level was 1.0% based on the total wet weight of the formulation.

TABLE 19
18% PVC Aqueous Coating Composition

| | |
|---|---|
| Material | Weight (g) |

Coating 16 formulation

| | |
|---|---|
| Letdown | |
| Composite 2 | 650.17 |
| Copolymer dispersion 2 | 206.00 |
| propylene glycol | 20.00 |
| TRITON ™ BD-405 wetting agent | 2.00 |
| NOPCO ™ NXZ defoamer | 2.00 |
| COASOL ™ coalescent | 27.01 |
| ACRYSOL ™ RM-2020 NPR rheology modifier | 4.20 |
| ACRYSOL ™ RM-8W rheology modifier | 3.18 |
| AMP 95 | 0.36 |
| water | 65.08 |
| TPO | 10.00 |
| acetone | 10.00 |
| Total | 1000.00 |

Coating 16 characteristics

| | |
|---|---|
| Total PVC | 18% |
| TPO level | 1.0% |

Coating 17 (Comparative Example)

A coating containing no polymer-encapsulated pigment particles was prepared using the following procedure to form the aqueous coating composition (Coating 17). The ingredients listed in Table 20 (grind) were mixed using a high speed Cowles disperser. The ingredients listed in Table 20 (let down) were added using a conventional lab mixer. The PVC of the resulting coating was 18%.The TPO level was 1.0% based on the total wet weight of the formulation.

TABLE 20
18% PVC Aqueous Coating Composition

| | |
|---|---|
| Material | Weight (g) |

Coating 18 formulation

| | |
|---|---|
| Grind | |
| water | 90.00 |
| OROTAN ™ 731A dispersant | 6.72 |
| NOPCO ™ NXZ defoamer | 1.00 |
| TI-PURE ™ R-706 pigment | 210.00 |
| Let down | |
| Copolymer dispersion 2 | 540.00 |
| propylene glycol | 20.00 |
| TRITON ™ BD-405 wetting agent | 2.00 |
| NOPCO ™ NXZ defoamer | 1.00 |
| COASOL ™ coalescent | 27.00 |
| ACRYSOL ™ RM-2020 NPR rheology modifier | 4.60 |
| ACRYSOL ™ RM-8W rheology modifier | 2.42 |
| AMP 95 | 0.58 |
| water | 74.68 |
| TPO | 10.00 |
| acetone | 10.00 |
| Total | 1000.00 |

Coating 17 characteristics

| | |
|---|---|
| Total PVC | 18% |
| TPO level | 1.0% |

Coating 18

A coating containing an aqueous dispersion of the polymer-encapsulated pigment particles was prepared using the following procedure to form the aqueous coating composition (Coating 18). The ingredients listed in Table 21 (grind) were mixed using a high speed Cowles disperser. The ingredients listed in Table 21 (let down) were added using a conventional lab mixer. The PVC of the resulting coating was 52%. The BP level was 0.1% based on total wet weight of formulation.

TABLE 21
52% PVC Aqueous Coating Composition

| | |
|---|---|
| Material | Weight (g) |

Coating formulation

| | |
|---|---|
| Grind | |
| water | 71.34 |
| propylene glycol | 7.58 |
| NATROSOL ™ 250 MBR thickener | 1.87 |
| AMP 95 | 0.18 |
| OROTAN ™ 1288 dispersant | 1.76 |
| TRITON ™ CF-10 wetting agent | 0.89 |
| NOPCO ™ NXZ defoamer | 0.76 |
| TI-PURE ™ R-706 pigment | 0.00 |
| CC-1000 | 158.04 |
| Let down | |
| Composite 3 | 420.40 |
| Copolymer dispersion 3 | 209.17 |
| TEXANOL ™ coalescent | 20.84 |
| TEGO ™ Foamex 825 defoamer | 0.76 |
| PRIMAL ™ TT-935 rheology modifier | 3.60 |
| AMP 95 | 0.4 |
| KATHON ™ LXE biocide | 1.00 |
| water | 97.41 |
| BP | 1.0 |
| acetone | 1.0 |
| Total | 1000 |

Coating 18 characteristics

| | |
|---|---|
| Total PVC | 52% |
| BP level | 0.1% |

Coating 19 (Comparative Example)

A coating containing no polymer-encapsulated pigment particles was prepared using the following procedure to form the aqueous coating composition (Coating 19). The ingredients listed in Table 22 (grind) were mixed using a high speed Cowles disperser. The ingredients listed in Table 22 (let down) were added using a conventional lab mixer. The PVC of the resulting coating was 52%. The BP was 0.1% based on the total wet weight of the formulation.

TABLE 22
52% PVC Aqueous Coating Composition

| | |
|---|---|
| Material | Weight (g) |

Coating formulation

| | |
|---|---|
| Grind | |
| Water | 160.00 |
| propylene glycol | 10.00 |
| NATROSOL ™ 250 MBR thickener | 2.50 |
| AMP 95 | 0.60 |
| OROTAN ™ 1288 dispersant | 4.89 |
| TRITON ™ CF-10 wetting agent | 1.00 |
| NOPCO ™ NXZ defoamer | 1.00 |
| TI-PURE ™ R-706 pigment | 280.00 |
| CC-1000 | 160.00 |
| Let down | |
| Copolymer dispersion 3 | 255.00 |
| TEXANOL ™ coalescent | 20.40 |
| TEGO ™ Foamex 825 defoamer | 1.00 |
| PRIMAL ™ TT-935 rheology modifier | 4.20 |
| AMP 95 | 0.40 |
| KATHON ™ LXE biocide | 1.00 |
| water | 96.01 |
| BP | 1.0 |
| acetone | 1.0 |
| Total | 1000 |

Coating 19 characteristics

| | |
|---|---|
| Total PVC | 52% |
| BP level | 0.1% |

Coating 20

A tinted coating (Coating 20)was prepared by adding organic phthalo blue colorant (888-7214 COLORTREND™ PHTHALO BLUE E. colorant, without polymer encapsulation) into coating 1. The organic phthalo blue colorant level was 4% based on the total wet weight of Coating 1. The PVC of the resulting coating was 18%. The BP level was 2.0% based on the total wet weight of the formulation.

Coating 21 (Comparative Example)

A tinted coating (Coating 21)was prepared by adding organic phthalo blue colorant (888-7214 COLORTREND™ PHTHALO BLUE E. colorant, without polymer encapsulation) into coating 2. The organic phthalo blue colorant level was 4% based on the total wet weight of Coating 2. The PVC of the resulting coating was 18%. The BP level was 2.0% based on the total wet weight of the formulation.

Coating 22 (Comparative Example)

A tinted coating (Coating 22) was prepared by adding polymer-encapsulated organic phthalo blue colorant (896-7210 CHROMA-CHEM™ PHTHALO BLUE GS. colorant, with polymer encapsulating the colorant as shown by a FEI Nova NanoSEM 630 system scanning transmission electron microscopy (FEI Company, Hillsboro, Oreg., USA)) into coating 2. The organic phthalo blue colorant level was 4% based on the total wet weight of Coating 2. The PVC of the resulting coating was 18%. The BP level was 2.0% based on the total wet weight of the formulation. STEM images were acquired on a FBI Nova NanoSEM 630 system (FEI Company, Hillsboro, Oreg., USA) equipped with a scanning transmission electron microscopy (STEM) detector.

### IV. Results

Table 23 listed the gloss retentions (%) and color changes (ΔE) of Coating 1 to Coating 19. As shown in Table 23, Coating 1 compared to Coating 2, Coating 3 to Coating 4, Coating 5 to Coating 6, Coatings 12 and 13 to Coating 11, Coating 14 to Coating 15, and Coating 16 to Coating 17, respectively, had higher gloss retentions (%). The higher the gloss retention was, the better the coating durability was. Coating 7 compared to Coating 8, and Coating 9 to Coating 10, and Coating 18 to Coating 19, respectively, had smaller color changes, and therefore better accelerated durability. Coatings 14 to 17 used BTA or TPO instead of BP as the photocrosslinker and showed similar results.

Coating 1 (BP loading being 2%) and Coating 3 (BP loading being 1%) were both coatings with polymer-encapsulated TiO₂, the gloss retention of Coating 3 was 123.4%, while that of Coating 1 was 65.6% (about 53.2% of that of Coating 3). The higher the BP loading level was, the lower the gloss retention was, and the poorer the coating durability was. Coating 2 (BP loading being 2%) and Coating 4 (BP loading being 1%) were both coatings with un-encapsulated TiO₂ (same PVC loading as Coatings 1 and 3). The gloss retention of Coating 4 was 87%, while that of Coating 2 was 9% (about 10.3% of that of Coating 4). The high the BP loading level was, the lower the gloss retention was, and the poorer the coating durability was. The coating durability was even poorer (from 53.2% to 10.3%) when the pigment was not encapsulated by polymer.

TABLE 23

| | | | | Accelerated | |
|---|---|---|---|---|---|
| | | | | Durability | |
| | | | | Test (1500 h) | |
| | | | Encapsulated | Gloss | Color |
| Coating | Coating | Photocosslinker/ | pigment | retention | change |
| ID | PVC | percent | percent %ⁱ | % | ΔE |
| 1 | 18% | BP/2.0% | 100% | 65.6% | — |
| 2* | 18% | BP/2.0% | 0% | 9.0% | — |
| 3 | 18% | BP/1.0% | 100% | 123.4% | — |
| 4* | 18% | BP/1.0% | 0% | 87.0% | — |
| 5 | 25% | BP/0.15% | 100% | 88.6% | |
| 6* | 25% | BP/0.15% | 0% | 53.4% | |
| 7 | 51% | BP/0.08% | 100% | — | 2.0 |
| 8* | 51% | BP/0.08% | 0% | — | 7.1 |
| 9 | 75% | BP/0.1% | 100% | — | 7.5 |
| 10* | 75% | BP/0.1% | 0% | — | 10.0 |
| 11* | 18% | BP/0.27% | 10% | 46.1% | — |
| 12 | 18% | BP/0.27% | 30% | 49.7% | — |
| 13 | 18% | BP/0.27% | 50% | 68.6% | — |
| 14 | 18% | BTA/1.0% | 100% | 82.2% | — |
| 15* | 18% | BTA/1.0% | 0% | 41.7% | — |
| 16 | 18% | TPO/1.0% | 100% | 102.6% | — |
| 17* | 18% | TPO/1.0% | 0% | 65.2% | — |
| 18 | 52% | BP/0.1% | 100% | — | 4.8 |
| 19* | 52% | BP/0.1% | 0% | — | 9.5 |

*comparative examples with all pigment particles being un-encapsulated
ⁱweight percentage of polymer-encapsulated pigment particles based on the total weight of all pigment particles

As shown in Table 24, Coating 20 was a coating composition comprising polymer-encapsulated pigment particles of the present invention and organic phthalo blue colorants without polymer encapsulation (888-7214 COLORTREND™ PHTHALO BLUE E. colorant). Coating 21 was a comparative coating comprising organic phthalo blue colorants without polymer encapsulation (888-7214 COLORTREND™ PHTHALO BLUE E. colorant) but no polymer-encapsulated pigment particles of the present invention. Coating 22 was a comparative coating composition comprising organic phthalo blue colorants with polymer encapsulation (896-7210 CHROMA-CHEM™ PHTHALO BLUE GS. Colorant) but no polymer-encapsulated pigment particles of the present invention. Coating 20 (organic colorant without polymer encapsulation+polymer-encapsulated inorganic pigment particles) comparing to coating 21 (organic colorant without polymer encapsulation) had a higher gloss retention (76.8% to 39.3%) and better durability. Coating durability was improved by the polymer-encapsulated inorganic pigment particles of the present invention. Coating 21 (organic colorant without polymer encapsulation), comparing to coating 22 (organic colorant with polymer encapsulation), had no significant gloss retention differences (39.3% to 38.0%). It was indicated that coating durability was not improved by polymer-encapsulated organic colorant. As used in this specification, colorant was organic, while pigment was inorganic.

TABLE 24

| | | | | | Accelerated |
|---|---|---|---|---|---|
| | | | | | Durability |
| Coat- | | | Photocoss- | Encapsulated | Test (900 h) |
| ing | Coating | Colorant/ | linker/ | TiO₂ | Gloss |
| ID | PVC | percent | percent | percent %^{l} | retention % |
| 20 | 18% | 888-7214/4% | BP/2.0% | 100% | 76.8% |
| 21* | 18% | 888-7214/4% | BP/2.0% | 0% | 39.3% |
| 22* | 18% | 896-7210/4% | BP/2.0% | 0% | 38.0% |

*comparative examples with all pigment particles being un-encapsulated
^{l}weight percentage of polymer-encapsulated pigment particles based on the total weight of all pigment particles

Table 25 showed the result of coating reflectance Y value changes during a long term DPUR test or an accelerated DPUR test. As shown in Table 25, there was no significant differences of the changes of reflectance Y values for Coating 1 (ΔY being −2.2) compared to Coating 2 (ΔY being −1.7), and Coating 7 (ΔY being −10.7) to Coating 8 (ΔY being −12.3). DPUR performance was not compromised by encapsulating pigments.

TABLE 25

| | | | Encapsulated | Accelerated | | Long term | |
|---|---|---|---|---|---|---|---|
| Coating | Coating | Photocosslinker/ | TiO₂ | DPUR test^{p} | | DPUR test^{q} | |
| ID | PVC | percent | percent %^{l} | Y0 | Y1 | Y0 | Y1 |
| 1 | 18% | BP/2.0% | 100% | 94.5 | 92.3 | — | — |
| 2* | 18% | BP/2.0% | 0% | 93.8 | 92.1 | — | — |
| 7 | 51% | BP/0.15% | 100% | — | — | 93.9 | 83.2 |
| 8* | 51% | BP/0.15% | 0% | — | — | 94.5 | 82.2 |

*comparative examples with all pigment particles being un-encapsulated
^{l}weight percentage of polymer-encapsulated pigment particles based on the total weight of all pigment particles
^{p/q}Y0 is the initial Y value and Y1 is the final Y value

1. An aqueous coating composition with a pigment volume concentration of from 10% to 75% comprising:
i) a pigment composition comprising, from 50% to 100% by weight based on the total weight of the pigment composition, polymer-encapsulated pigment particles;
ii) a polymer shell encapsulating the polymer-encapsulated pigment particles; and
iii) from 0.1% to 2.0% by weight, based on the total weight of the aqueous coating composition, a photocrosslinker;
wherein the photocrosslinker is polymerized in or blended with the polymer shell of the polymer encapsulated pigment.

2. (canceled)

3. An aqueous coating composition with a pigment volume concentration of from 10% to 75% comprising:
i) a pigment composition comprising from 50% to 100%, by weight based on the total weight of the pigment composition, a polymer encapsulated pigment;
ii) a polymer shell encapsulating the polymer encapsulated pigment;
iii) one or more additional aqueous copolymer dispersion that comprises copolymer; and
iv) from 0.1% to 2.0% by weight based on the total weight of the aqueous coating composition, a photocrosslinker;
wherein the photocrosslinker is polymerized in or blended with the copolymer of one or more additional aqueous copolymer dispersion.

4. An aqueous coating composition with a pigment volume concentration of from 10% to 75% comprising:
i) a pigment composition comprising from 50% to 100%, by weight based on the total weight of the pigment composition, a polymer encapsulated pigment;
ii) a polymer shell encapsulating the polymer encapsulated pigment; and
iii) from 0.1% to 2.0% by weight based on the total weight of the aqueous coating composition, a photocrosslinker;
wherein the photocrosslinker is freely present in the aqueous coating composition outside of the polymer shell.

5. The aqueous coating composition according to claim 1 wherein the photocrosslinker is a benzophenone derivative, a benzotriazole derivative, an acylphosphine oxide, a bisacylphosphine oxide, or a mixture thereof.

6. The aqueous coating composition according to claim 1 wherein the polymer shell has an average thickness of from 10 nanometers to 200 nanometers and a minimum film formation temperature (MFFT) of from −35° C. to 60° C.

7. The aqueous coating composition according to claim 1 wherein the polymer shell is a polymer comprised of structural units of an ethylenically unsaturated nonionic monomer.

8. The aqueous coating composition according to claim 7 wherein the polymer shell comprises, in percentage by weight based on the dry weight of the polymer shell, from 0.1% to 10% of a polymer structural units of an ethylenically unsaturated monomer with at least one functional group selected from the group consisting of carboxyl, carboxylic anhydride, hydroxyl, amide, amine, sulphonate, phosphonate or the mixture thereof.

9. The aqueous coating composition according to claim 1 wherein the pigment is an inorganic pigment.

10. The aqueous coating composition according to claim 9 wherein the pigment is TiO_{2.}
